(19) United States
(12) Patent Application Publication
(10) Pub. No.: US 2014/0238617 A1
(43) Pub. Date: Aug. 28, 2014

(54) SYSTEM AND METHOD FOR REMOVAL OF A LAYER

(71) Applicant: GENERAL ELECTRIC COMPANY, Schenectady, NY (US)

(72) Inventors: Sultan Shair, Ismaning (DE); Martin Petersen, Poing (DE)

(73) Assignee: GENERAL ELECTRIC COMPANY, Schenectady, NY (US)

(21) Appl. No.: 13/779,883

(22) Filed: Feb. 28, 2013

(51) Int. Cl. B32B 43/00

(52) U.S. Cl. CPC B32B 43/006
USPC 156/708; 156/750; 156/754; 156/758; 156/714

(57) ABSTRACT

A system includes a first drive unit used for driving at least one of a release device, a gripper device, and a second drive unit used for driving a support device. The release device is a vacuum device. The vacuum device is coupled to a vacuum source and applies a suction force against an edge portion of one layer among a first layer disposed on a second layer. Another layer among the first layer and the second layer is held by a support surface of the support device. The vacuum device and/or the support device are movable upwards and downwards for peeling the edge portion of the one layer from the other layer. The gripper device holds the peeled edge portion of the one layer and the support device or the gripper device is movable along at least one axis for removing the one layer from the other layer.

### BACKGROUND

The disclosure relates generally to a layer removal system, and more particularly to a system and method for removing backing paper layers from a prepreg material, an adhesive material, for example.

Generally, a pre-impregnated material (also referred to as a “prepreg”) is used in composite manufacturing applications, for example building a composite laminate. The prepreg material typically includes a fabric impregnated with a thermosetting resin, which can either be sandwiched between two layers of backing paper layers or have a single layer of backing paper layer. An adhesive material that is often used in parallel with the composite laminate may also be sandwiched between backing paper layers. The backing paper layers protect the material from environmental factors, such as moisture and debris, and furthermore provide dimensional stability during handling. For a single layer of backing paper layer, the base fabric can be laid directly onto a preforming mold or the composite laminate, and then the backing paper layer may be removed from the base fabric material. In some other cases, the backing paper layer is peeled and removed entirely from the base fabric material or the sandwiched fabric and then the base fabric is laid on the composite laminate or the preforming mold.

Conventionally, removing the backing paper layer from the prepreg or adhesive material is done by a manual process. The skill of the individual is used to ensure that the backing paper layer is removed properly and swiftly. Often, in the manual process, sharp objects are used for releasing or peeling the backing paper layer, and subsequently remove the backing paper layer entirely from the prepreg or adhesive material. Such a process of peeling the backing paper layer is tedious and may cause damage to the material, and may not be efficient to remove the backing paper layer from the material. Additionally, the manual process of removing backing paper layer may lack repeatability, and reliability.

Thus, there is a need for an improved system and method for efficiently peeling and removing a layer from a material.

### BRIEF DESCRIPTION

In accordance with one exemplary embodiment, a system for separating one layer from another layer is disclosed. The system includes a first drive unit coupled to a release device. The release device is configured to contact the one layer among a first layer disposed on a second layer. A support surface of the support device is configured to hold the second layer. Further, the release device is configured to apply a release force against an edge portion of one layer. The release device or the support device is movable to peel the edge portion of the one layer from the other layer. Further, the system includes a gripper device coupled to the first drive unit and configured to hold the peeled edge portion to remove the one layer entirely from the other layer.

In accordance with another exemplary embodiment, a method for separating one layer from another layer is disclosed. The method includes applying a release force via a release device against an edge portion of the one layer among a first layer disposed on a second layer. Further, the method includes holding the other layer among the first layer and the second layer by a support surface of a support device. The method includes moving at least one of the support device and the release device to peel the edge portion of the one layer from the other layer. Further, the method includes holding the peeled edge portion of the one layer through a gripper device. The method includes moving at least one of the support device and the gripper device to remove the first layer entirely from the second layer.

### DRAWINGS

These and other features and aspects of embodiments of the present disclosure will become better understood when the following detailed description is read with reference to the accompanying drawings in which like characters represent like parts throughout the drawings, wherein:

FIG. 1 is an illustration of a plurality of layers in accordance with one exemplary embodiment;

FIG. 2 is an illustration of a system having a first drive unit, a gripper device, and a vacuum device in accordance with one exemplary embodiment;

FIG. 3 is an illustration of a support device having a second drive unit and coupled to a fluid blower and a vacuum source in accordance with one exemplary embodiment;

FIG. 4 is an illustration of a system shown in FIG. 1-3, coupled to a plurality of sensors, a control unit, and a blower in accordance with one exemplary embodiment;

FIG. 5a is an illustration of a system shown in FIG. 4, having a vacuum device applying a suction force on a first layer disposed on a second layer held by a support device in accordance with one exemplary embodiment;

FIG. 5b is a top view of the system 5a. illustrating application of a suction force on a first layer using a vacuum device in accordance with one exemplary embodiment;

FIG. 6a is an illustration of a system shown in FIG. 5a, showing a vacuum device peeling a first layer disposed on a second layer and held by a support device in accordance with one exemplary embodiment;

FIG. 6b is a top view of the system 6a, illustrating a first layer held by a gripper device in accordance with one exemplary embodiment; and

FIG. 6c is a top view of the system 6a, illustrating removal of a first layer by a gripper device in accordance with one exemplary embodiment.

### DETAILED DESCRIPTION

While only certain features of embodiments of the invention have been illustrated and described herein, many modifications and changes will occur to those skilled in the art. It is, therefore, to be understood that the appended claims are intended to cover all such modifications and changes as fall within the true spirit of the invention.

Embodiments discussed herein disclose a system and method for separating tapes or materials or films or layers or papers, which are adhered to each other. More particularly, certain embodiments of the present disclosure disclose a system and method for removing a first layer adhered to a second layer. The method includes applying a release force via a release device by contacting the release device against an edge portion of a first layer disposed on the second layer held by a support surface of a support device. Further, the method includes peeling the edge portion of the first layer by moving at least one of the support device and the release device. The method further includes holding the peeled edge portion of the first layer using a gripper device and removing the first layer entirely from the second layer by moving at least one of the gripper device and the support surface along at least one axis. In accordance with certain embodiments, the exemplary method may be an automated method within a manual process or a completely automated process. In a specific embodiment, a user may activate a backing paper removal process via an interface or a start/stop button.

More specifically, certain embodiments of the present disclosure disclose a system and method for removing the backing paper layer adhered to a base fabric material. In certain other embodiments, the base fabric material is sandwiched between two backing paper layers. In certain other embodiments, the backing paper may be on one surface of the base fabric material. The system includes a first drive unit, a second drive unit, a release device, a support device, and a gripper device. The first drive unit is used for driving one or more components of the system, such as the release device, and the gripper device. The second drive unit is used for driving the support device. The release device and the support device are used for peeling the backing paper layer, and the gripper is used for holding the peeled backing paper layer and for removing the backing paper layer from the base fabric material. Further, the support device is also used to hold the base fabric, so as to prevent slippage of the base fabric material. In certain other embodiments, the support device is also used for removing the backing paper layer from the base fabric material.

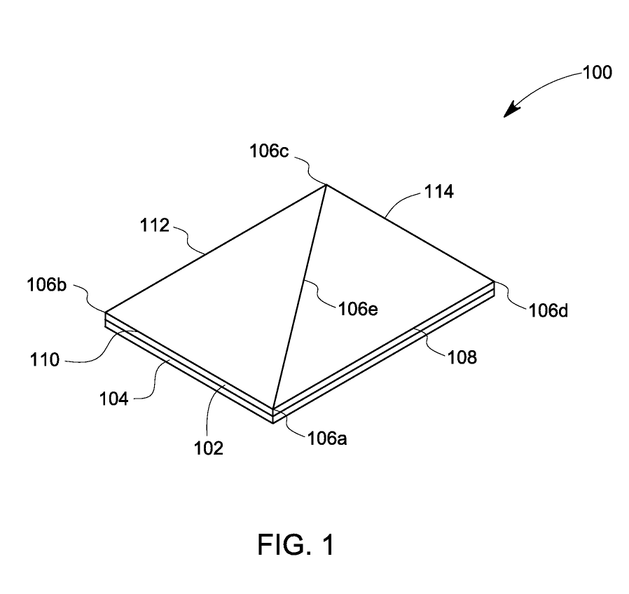

FIG. 1 illustrates a plurality of layers 100 in accordance with one exemplary embodiment. In the illustrated embodiment, the plurality of layers 100 includes a first layer 102 and a second layer 104. The number of layers depicted in FIG. 1 is for illustration purpose only and number of layers may vary based on the application. In one embodiment, the first layer 102 and second layer 104 are adhered to each other. In some embodiments, the plurality of layers 100 may include composite plies, adhesive plies, or the like. The plurality of layers 100 may have a flat, contoured or other geometric surface. The composite plies may include prepregs with any fiber and any resin, or dry fabric with any fiber either tackified or not tackified. Other materials for the plies may include cores such as foam, metals, honeycomb, bagging materials, peel plies, release films, bleeders, breathers, bagging film, and other suitable materials. The materials listed herein may be used for composite manufacturing application, for example, a composite laminate. In certain embodiments, the first layer 102 may be a backing paper and the second layer 104 may be a base fabric, which is impregnated with a thermosetting resin. In some embodiments, the second layer 104 may be sandwiched between two first layers 102. Various other materials are also envisioned, and the materials listed above should not be construed as a limitation of the present invention.

It should be noted herein that the terms “one layer” and “other layer” may be referred to either of the first layer 102 or the second layer 104 and may be used interchangeably. For example, in one embodiment, one layer may be referred to as the first layer 102 and the other layer may be referred to as the second layer 104. In another embodiment, one layer may be referred to as the second layer 104 and the other layer may be referred to as the first layer 102.

In the illustrated embodiment, the first layer 102 includes an edge portion 106a formed between intersecting sides 108, 110. In certain other embodiments, the edge portion of the first layer 102 may be referred to 106b, 106c, 106d formed between the corresponding intersecting sides 108, 110, 112, 114 of the first layer 102. The illustrated edge portion 106a is used for explaining the embodiments of the disclosure and should not be construed as a limitation of the present technique. In certain other embodiments, the first layer 102 may include an edge portion 106e formed by slicing an upper surface diagonally along the first layer 102. Various other possible edge portions of the first layer 102 are also envisioned. In the illustrated embodiment, the first layer 102 and the second layer 104 have a rectangular shape. It should be noted herein that the shape and size of the layers may vary depending on the application.

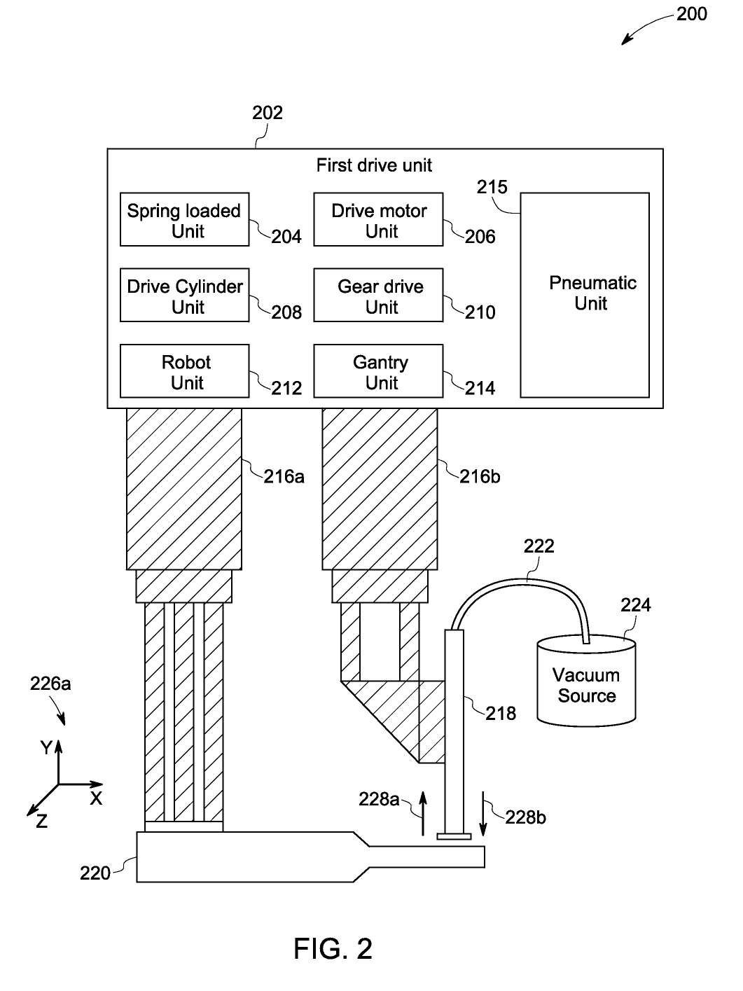

FIG. 2 illustrates a system 200 used for removing the first layer 102 from the second layer 104 (illustrated in FIG. 1) in accordance with one exemplary embodiment. In the illustrated embodiment, the system 200 includes a first drive unit 202, a release device 218, and a gripper device 220. In the illustrated embodiment, the release device 218 is a vacuum device. It should be noted herein that the terms “release device” and the “vacuum device” are used interchangeably. Although vacuum device is discussed is greater detail herein, in other embodiments, the release device 218 may also include other suitable device capable of exerting a release force for removing the first layer from the second layer. A vacuum source 224 is coupled to a vacuum channel 222, for applying a vacuum force against the edge portion of the first layer discussed in greater detail below. In other embodiments, the release device may be a sticky device or a sharp surface device.

In the illustrated embodiment, the first drive unit 202 includes one or more driving means, which as per one embodiment includes at least one of a spring loaded unit 204, a drive motor unit 206, a drive cylinder unit 208, a gear drive unit 210, a robot unit 212, a gantry unit 214, and a pneumatic unit 215. The first drive unit 202 is configured to move at least one of the vacuum device 218 and the gripper device 220 independently or simultaneously. In one embodiment, the support device may be driven by a second drive unit, similar to the illustrated first drive unit 202. In another embodiment, the support device may be stationary. In certain embodiments, the first drive unit 202 may be a portable unit, and the vacuum device 218, support device, and the gripper unit 220 may be plugged to the portable unit based on the application need.

The first drive unit 202 includes a first end effector arm 216a for moving the gripper device 220. Similarly, the first drive unit 202 includes another first end effector arm 216b for independently moving the vacuum device 218. In one embodiment, the first drive unit 202 moves the gripper device 220 along at least one axis. It should be noted herein that the gripper device 220 and the vacuum device 218 may be mounted in any position. For example, the gripper device 220 and the vacuum device 218 may be mounted vertically or at a predefined tilted angle. In the illustrated embodiment, the gripper device 220 may be movable along a plurality of axes 226a for example, an x-axis, y-axis, and z-axis. The axis is determined based on the application and may vary depending on the need of the application and design criteria. Similarly, the first drive unit 202 may move the vacuum device 218 along at least one axis for contacting the first layer and also for retracting from the first layer. In such embodiments, the vacuum device 218 may be movable along the at least one axis among the plurality of axes for contacting the first layer and also for retracting from the first layer. In one embodiment, the first drive unit 202 moves the vacuum device 218 upwards and downwards along a vertical direction as represented by reference numeral 228a, and 228b respectively, for enabling peeling of the edge portion of the first layer from the second layer. In some other embodiments, the vacuum device 218 may move towards and away from the first layer along one or more other directions to enable peeling of the edge portion of the first layer from the second layer.

In one example, the robot unit 212 may be used in conjunction with the pneumatic unit 215 as a supplementary driving unit. In certain embodiments, the first drive unit 202 is configured to operate at a speed. The speed at which the first drive unit 202 operates may be varied, and may be determined based on the type of material of the plurality of layers. The configuration and speed of operation of the first drive unit 202 may vary depending on the application, the material of the plurality of layers, number of layers, and design criteria.

In the illustrated embodiment, the vacuum device 218 is coupled to the first end effector arm 216b of the first drive unit 202. The vacuum source 224 may be a venture nozzle, a vacuum pump, or the like. In certain other embodiments, the design of the vacuum device 218 may vary depending on the application and type of material of the plurality of layers. In another embodiment, a plurality of such vacuum devices 218 may be used.

In the illustrated embodiment, the gripper device 220 is coupled to the first end effector arm 216a of the first drive unit 202. In some other embodiments, the gripper device 220 may be operated independently of the first drive unit 202. In one embodiment, the gripper device 220 has a plier shape and is designed to clamp the first layer, before the vacuum device 218 is retracted along the at least one axis by the first drive unit 202. In a specific embodiment, the vacuum source 224 is a high flow vacuum source. The vacuum source 224 may be controlled via a valve (not illustrated in FIG. 2) to allow the high suction force through the vacuum device 218. In such an embodiment, the vacuum device 218 connected to the vacuum source 224, is used to release the edge portion of the first layer. The high suction force of the vacuum source 224 is further used to pull the first layer up, while the vacuum device 218 is retracted. Further, the gripper device 220 is used to clamp the first layer. In certain other embodiments, the gripper device 220 may have a needle shape or a forceps shape depending on the application need and design criteria. Various other shapes of the gripper device 220 are also envisioned without limiting the scope of the present technique.

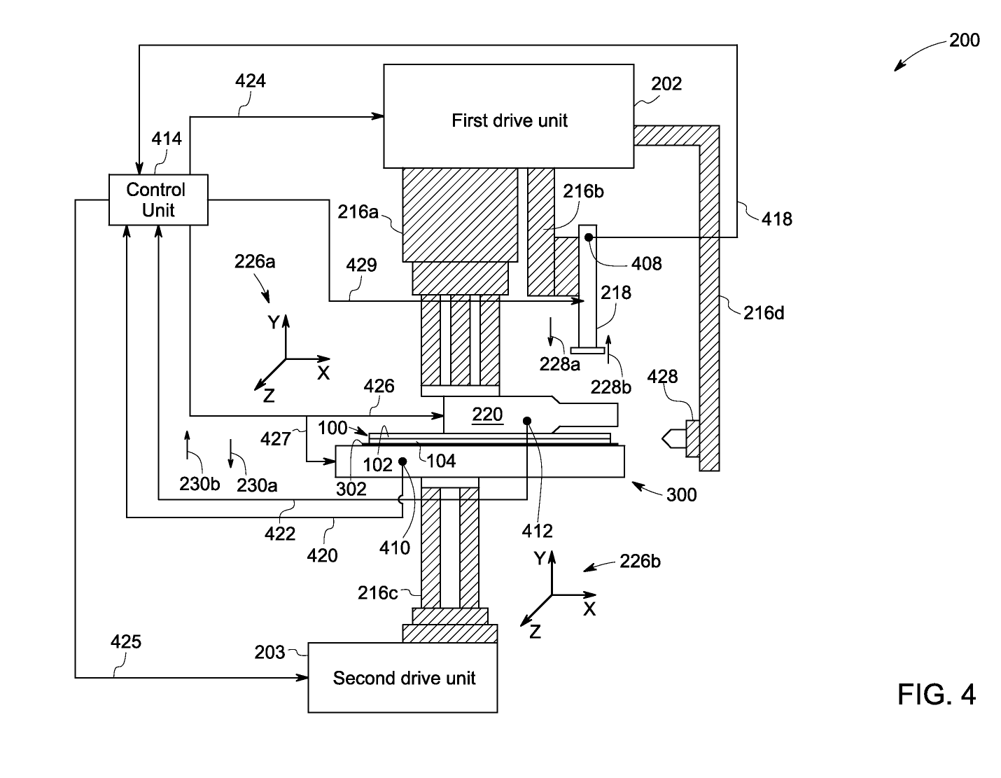

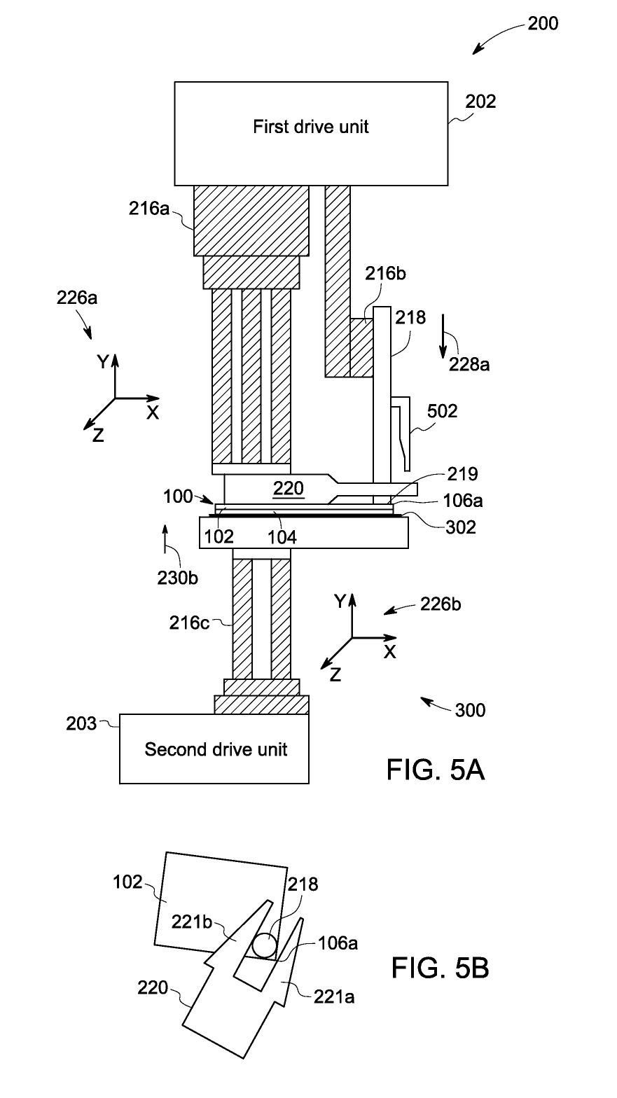

In one embodiment, the gripper device 220 has two gripper arms (illustrated in FIG. 5b), and the vacuum device 218 may be located in-between the gripper arms. The gripper device 220 is actuated so as to clamp the edge portion of the first layer using the gripper arms, after the vacuum device 218 peels the edge portion of the first layer. The gripper device 220 is then further actuated to enable removing of the first layer entirely from the second layer. In another embodiment, a plurality of such gripper devices 220 may be used. In one embodiment, each end effector arms 216a, 216b, 216c and 216d (illustrated in FIG. 4) may be actuated independently.

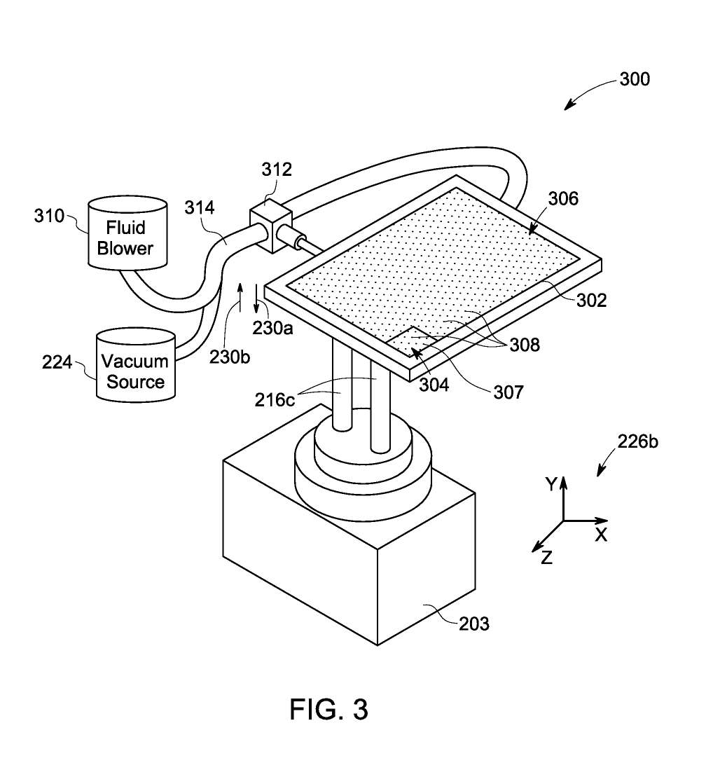

FIG. 3 is an illustration of a support device 300 having a support surface 302 in accordance with one exemplary embodiment. In one embodiment, the support device 300 is coupled to a second end effector arm 216c of a second drive unit 203. In another embodiment, the support device 300 may be stationary. In one embodiment, the support device 300 is configured to move upwards and downwards, along a vertical direction as represented by reference numeral 230a, and 230b respectively, for peeling the first layer from the second layer. In some other embodiments, the support device 300 may move towards and away from the vacuum device along one or more other directions to enable peeling of the edge portion of the first layer from the second layer. Additionally, the second drive unit 203 may move the support device 300 along at least one axis for removing the first layer entirely from the second layer. In the illustrated embodiment, the support device 300 may be movable along a plurality of axes 226b represented by an x-axis, y-axis, and z-axis. The axis may be determined based on the application and may vary depending on the need of the application and design criteria. In some other embodiments, the support device 300 may be actuated independently of the second drive unit 203. In certain other embodiments, the support device 300 is an end product, over which the second layer among the plurality of layers is affixed.

In the illustrated embodiment, the support device 300 has a rectangular shape. The shape of the support device 300 may vary depending on the application and design criteria. Various other shapes of the support device 300 are also envisioned. The support device 300 includes a support surface 302 having a plurality of holes 308 which are coupled to at least one of a fluid blower 310 and a vacuum source 224. The fluid blower 310 is provided for blowing a fluid to the support surface 302 to enable easy lifting or removal of the second layer from the support surface 302. The fluid may include air or other gaseous medium or liquid depending on the type of material of the plurality of layers, application, and design criteria. Similarly, the vacuum source 224 is provided for applying the suction force via the plurality of holes 308 against the second layer disposed on the support surface 302 for properly holding the second layer against the support surface 302. The vacuum source 224 and the fluid blower are coupled to the support device 300 via a channel 314. A control valve 312 is provided for controlling flow through the channel 314.

In the illustrated embodiment, the support surface 302 includes a high vacuum region 304 and a low vacuum region 306. The high vacuum region 304 is positioned proximate to the one edge portion or one corner portion 307 of the support surface 302. The high vacuum region 304 of the support device 300 has a high vacuum flow. The position of the high vacuum region 304 may vary depending on the shape of the support device 300, the support surface 302, and/or the plurality of layers. In one embodiment, the high vacuum region 304 may be one quarter of the support surface 302 and the low vacuum region 306 may be three quarters of the support surface 302. In some other embodiments, the size and position of the high vacuum region 304 and the low vacuum region 306 may vary depending on the application and design criteria. The illustrated embodiment should not be construed as a limitation of the present technique. In a specific embodiment, the vacuum source 224 is a high flow vacuum source. The suction force from the vacuum source 224 may be controlled via a valve (not illustrated in FIG. 3) to generate a high holding force through high vacuum region 304 and the low vacuum region 306 of the support surface 302. In such an embodiment, the support surface 302 coupled to the vacuum source 224, is used to hold the edge portion of the first layer and also the remaining portion of the first layer against the support surface 302, using the high suction force.

In one embodiment, each hole among the plurality of holes 308 may have a diameter of 1 mm. In some other embodiments, the plurality of holes 308 may have a different size depending on the application and design criteria. In one embodiment, the suction force or holding force through each hole 308 of each vacuum region can be individually controlled. Each hole among the plurality of holes 308 in the high vacuum region 304, or if necessary in the low vacuum region 306 may be designed to be independently controlled for either applying controlled suction force or for supplying fluid to the support surface 302. The low vacuum region 308 is required to hold the second layer against the support surface 302 so as to minimize any damage to the layers. The plurality of holes 308 in the high vacuum region 304 are used to maintain a high suction force against the second layer. In one embodiment, the high suction pressure may be about 0.2 bars absolute. The plurality of holes 308 in the low vacuum region 306 are designed to be collectively controlled for either applying suction force or for supplying fluid to the support surface 302. The plurality of holes 308 in the low vacuum region 306 is used to maintain a low suction pressure so as to ensure that the second layer is in contact with the support surface 302, and prevent sliding the second layer from the support surface 302. In one embodiment, the low suction pressure may be about 0.7 bars absolute. The suction pressure of the high vacuum region 304 and low vacuum region 306 may vary based on the application, properties of the layers, and design criteria. In one embodiment, the plurality of holes 308 in the high vacuum region 304, and the low vacuum region 306 are used to inject the fluid received from the fluid blower 310, so as to assist the release of the second layer from the support surface 302. In certain embodiments, the high vacuum region 304 of the support device 300 may enhance the releasing of the second layer 104 from the support device 300, compared to the low vacuum region 306. In certain other embodiments, the low vacuum region 306 of the support 300 may enhance the releasing of the second layer 104 from the support device 300, compared to the high vacuum region 304. In one embodiment, the vacuum device 218 has a higher suction force in comparison with the holding force exerted by the low or high vacuum region 306, 304 in order to smoothly peel the first layer 102 and prevent the second layer 104 from lifting off from the support device 300.

The support surface 302 may be at least one of a cooled surface, a vibrating surface, a sticky surface and a non-sticky surface. In one specific embodiment the support surface 302 may be a mold. In one embodiment, the support surface 302 of the support device 300 may be a sticky surface for affixing the second layer to the support surface 302. In such embodiments, the second layer is a base fabric. In certain embodiments, the affixing materials may not be required for sticking the second layer to the support surface 302. The second layer may be automatically fixed to the support surface 302. Various other means of affixing the second layer on the support surface 302 may also be used. In some embodiments, the support device 300 may be an end-product (also referenced as an “off-the-shelf product”) having the support surface 302 over which the second layer among of the plurality of layers is affixed.

FIG. 4 is an illustration of a system shown in FIGS. 1-3, arranged for peeling and removing the first layer 102 disposed on the second layer 104. In the illustrated embodiment, the system further includes a plurality of sensors 408, 410, 412, a control unit 414, and a blower 428.

In the illustrated embodiment, the plurality of layers 100 having the first layer 102, the second layer 104 is disposed on the support surface 302 of the support device 300. In this embodiment, the first drive unit 202 moves the vacuum device 218 via the first end effector arm 216b, the gripper device 220 via the first end effector arm 216a, and the blower 428 via a first end effector arm 216d of the first drive unit 202. The second drive unit 203 moves the support device 300 via the second end effector arm 216c. The first drive unit 202 moves at least one of the vacuum device 218 vertically downwards as represented by reference numeral 228a, and the gripper device 220 horizontally sideways as represented by reference numeral 226a. The second drive unit 203 moves the support surface 300 vertically upwards as represented by reference numeral 230b.

In one embodiment, the sensor 408 is a contact sensor, which may sense the layer based on touch, or the like. In some other embodiments, the sensor 408 may be a vision sensor, which may sense the layer based on vision, or the like. The sensor 408 is used for sensing contacting of the first layer 102 by the vacuum device 218. Similarly, the sensor 410 may be used for sensing at least one of contacting of the second layer 104 by the support surface 302 of the support device 300, the position of the second layer 104 on the support surface 302, and removal of the first layer 102 entirely from the second layer 104. Further, the sensor 412 is provided for sensing the holding of the peeled edge portion of the first layer 102 by the gripper device 220, and removal of the first layer 102 entirely from the second layer 104. The number of sensors and their relative positions may vary depending on the application.

In the illustrated embodiment, the plurality of sensors 408, 410, 412 generate output signals 418, 420, 422 respectively. The control unit 414 is communicatively coupled to the plurality of sensors 408, 410, 412 for receiving the generated output signals 418, 420, 422. It should be noted herein that the term “communicatively coupled” may either be referred to a wired communication or a wireless communication. In one embodiment, the control unit 414 is configured for generating a control signal 424 for controlling the first drive unit 202 based on the output signals 418, 422. Further, the control unit 414 is configured for generating a control signal 425 for controlling the second drive unit 203 based on the output signal 420. In one embodiment, the control unit 414 outputs the control signal 424 to the first drive unit 202 for actuating the gripper device 220 to hold the peeled edge portion of the first layer 102 based on the output signal 418. Similarly, in one embodiment, the control unit 414 outputs the control signal 424 to the first drive unit 202 to control the movement of first end effector arms 216a, 216b, for relative positioning of the gripper device 220, and the vacuum device 218 respectively. Further, the control unit outputs the control signal 425 to the second drive unit 203 to control the movement of the second end effector arm 216c for relative positioning of the support device 300. Also, in some embodiments, the control signal 425 is used to activate the support device 300 for injecting a fluid via the fluid blower (shown in FIG. 3) to release the second layer 104 from the support surface 302. In some embodiments, the control signal 425 may be used for generating an alarm signal (not illustrated in FIG. 4) for positioning of the second layer 104 on the support surface 302. In certain other embodiments, the control signal 425 may be used for actuating the second end effector arm 216c to move the support device 300 in any one of the plurality of axes 226b for removing the first layer 102 entirely from the second layer 104, based on the output signal 420. Additionally, the control unit 414 outputs the control signal 424 to the first drive unit 202 for actuating the first end effector arm 216a of the first drive unit 202 to move the gripper device 220 in any one of the plurality of axes 226a for removing the first layer 102 entirely from the second layer 104 based on the output signal 422. In one embodiment, the control unit 414 may output a control signal 426 for actuating the gripper device 220 independently of the first drive unit 202 to move in any one of the plurality of axes 226a for removing the first layer 102 entirely from the second layer 104. Also, control unit 414 may output a control signal 426 to the gripper device for holding the peeled edge portion of the first layer 102. In another embodiment, the control unit 414 may output a control signal 427 for actuating the support device 300 independently of the second drive unit 203 to move in any one of the plurality of axes 226b for removing the first layer 102 entirely from the second layer 104. In another embodiment, the control unit 414 may output a control signal 429 for actuating the vacuum device 218 independently of the first drive unit 202, to move along axes 228a, 228b for removing the first layer 102 entirely from the second layer 104. The number of sensors and their relative positions may vary depending on the application. In the illustrated embodiment, the first end effector arm 216d of the first drive unit 202 is driven for positioning the blower 428 proximate to the plurality of layers 100 for injecting the fluid between the first layer 102 and the second layer 104, so as to assist releasing of the edge portion 106a of the first layer 102 from the second layer 104.

The vacuum device 218 and the support device 300 are movable simultaneously or independently to peel the edge portion of the first layer 102 from the second layer 104. In one embodiment, the vacuum device 218 moves towards and away as represented by reference numerals 228a, 228b, from the first layer 102, and the support device 300 moves towards and away as represented by reference numeral 230a, 230b, from the vacuum device 218 for peeling the edge portion of the first layer 102. In one embodiment, the vacuum device 218 and the support device 300 are configured to move independently. In such an embodiment, the second layer 104 may be held by the support surface 302 via the high vacuum and low vacuum regions of the support device 300 and the edge portion of the first layer 102 may be held by the vacuum device 218. In another embodiment, the vacuum device 218 and the support device 300 are configured to move simultaneously. In such an embodiment, the first layer 102 may be held by the support surface 302 via the high vacuum region and the low vacuum region and the second layer 104 may be held by the vacuum device 218 by maintaining the suction force at an edge portion of the second layer 104.

FIG. 5a is an illustration of a system shown in FIG. 4, having a vacuum device 218 applying the suction force on the edge portion 106a of the first layer 102 in accordance with one exemplary embodiment. In the illustrated embodiment, the plurality of layers 100 are placed on the support surface 302 of the support device 300. The second layer 104 of the plurality of layers 100 is held by the support surface 302, as described previously. The second drive unit 203 moves the support device 300 via the second end effector arm 216c along a direction represented by reference numeral 230b, to a predetermined position. In some embodiments, the support device 300 may be moved by the first drive unit 202, through a separate end effector arm (not illustrated in FIG. 5a). Further, the first drive unit 202 moves the vacuum device 218 via the first end effector arm 216b along a direction represented by reference numeral 228a for contacting the first layer 102 disposed on the second layer 104 held by the support surface 302. The first drive unit 202 further moves the gripper device 220 via the first end effector arm 216a along a direction represented by reference numeral 226a to a predetermined position the gripper device 220 in-between the vacuum device 218. The vacuum device 218 applies the suction force against the edge portion 106a of the first layer 102. Tip 219 of the vacuum device 218 is designed to create a good vacuum seal so as to enable easy releasing of the first layer 102 from the second layer 104.

In the illustrated embodiment, the system further includes a peeled edge holder device 502 coupled to the vacuum device 218. In one embodiment, the peeled edge holder device 502 is driven by the first drive unit 202 via the vacuum device 218. In another embodiment, the peeled edge holder device 502 may be coupled to the support device 300. The peeled edge holder device 502 is held either in a lock position or in an unlock position. In the illustrated embodiment, the peeled edge holder device 502 is in the unlock position. In one embodiment, a separate peeled edge holder device 502 may not be required for holding the peeled edge portion 106e of the first layer 102. In such an embodiment, instead of using a separate peeled edge holder device 502, the blower 428 (illustrated in FIG. 4) itself may be used as a peeled edge holder device 502. The blower 428 may inject air between the first layer 102 and the second layer 104 to prevent the peeled edge portion 106e of the first layer 102 from falling on the second layer 104. In one embodiment, the peeled edge holder device 502 may be a mechanical component.

FIG. 5b shows a top view of the system shown in FIG. 5a, illustrating application of the suction force against the edge portion 106a of the first layer 102 via the vacuum device 218 in accordance with one exemplary embodiment. In the illustrated embodiment, the vacuum device 218 is positioned over the first layer 102 contacting the edge portion 106a of the first layer 102. In on embodiment, the gripper device 220 is positioned in-between the vacuum device 218 via gripper arms 221a, 221b.

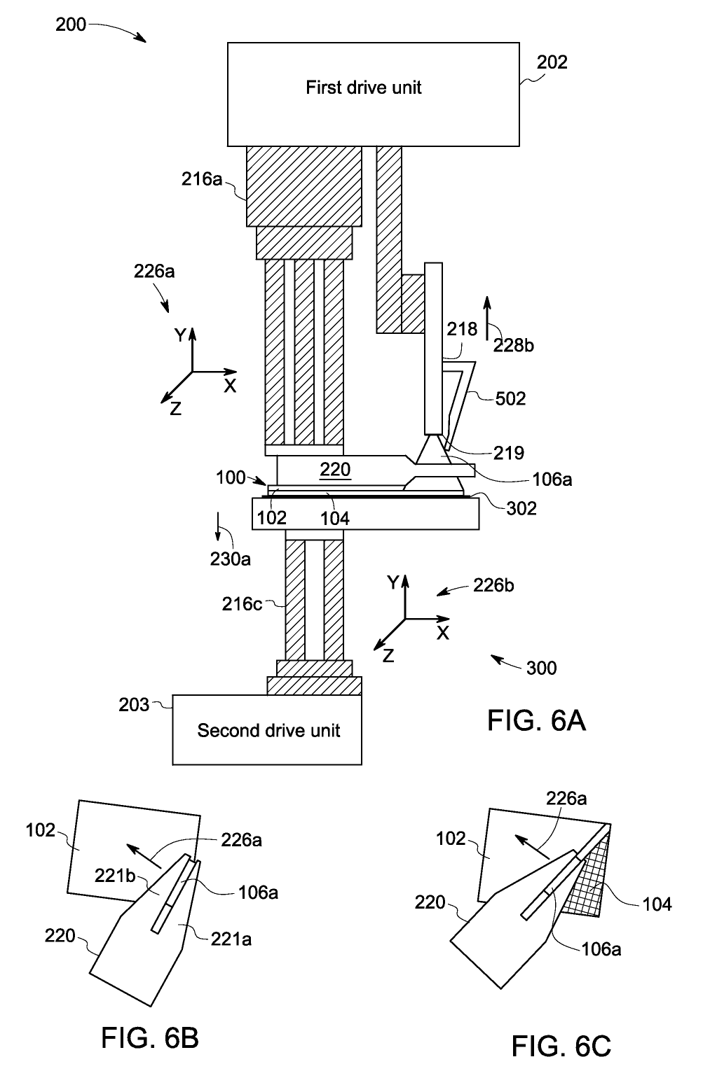

FIG. 6a is an illustration of a system shown in FIG. 5a, showing the vacuum device 218 peeling the edge portion 106a of the first layer 102 disposed on the second layer 104 held by the support surface 302 of the support device 300 in accordance with one exemplary embodiment. In one embodiment, the vacuum device 218 is movable towards and away along a direction represented by reference numerals 228a, 228b, from the first layer 102 to peel the edge portion 106a of the first layer 102 from the second layer 104. In some other embodiments, the vacuum device 218 is movable towards and away along a direction represented by reference numerals 228a from the first layer 102 to peel the edge portion 106a of the first layer 102 from the second layer 104. In another embodiment, the support device 300 is movable towards and away along a direction represented by reference numerals 230a, 230b, from the vacuum device 218 to peel the edge portion 106a of the first layer 102 from the second layer 104. In the illustrated embodiment, the vacuum device 218 moves away from the first layer 102 along a direction represented by reference numerals 228a, 228b to peel the edge portion 106a of the first layer 102 from the second layer 104. In one embodiment, the vacuum device 218, the support device 300 may peel the edge portion 106a of the first layer 102 from the second layer 104 in a single stroke movement. In some other embodiments, the vacuum device 218, the support device 300 may undergo a plurality of strokes, until the edge portion 106a of the first layer 102 is peeled from the second layer 104. The support device 300 is driven by the second drive unit 203, and the vacuum device 218 is driven by the first drive unit 202 so as to move at a speed to enable peeling of the first layer 102 from the second layer 104.

In the illustrated embodiment, the peeled edged holder device 502 is in the lock position for supporting the peeled edge portion 106a of the first layer 102, so as to prevent falling of the first layer 102 on to the second layer 104.

FIG. 6b is a top view of the system shown in FIG. 6a, illustrating holding of the peeled edge portion 106a of the first layer 102 by the gripper device 220 in accordance with one exemplary embodiment. The vacuum device 218 holds the peeled edge portion 106a of the first layer 102 and retracts upwardly along a direction represented by reference numeral 228b (shown in FIG. 6a) to allow the gripper device 220 to clamp the peeled edge portion 106a of the first layer 102. The gripper device 220 clamps the peeled edge portion 106a by closing the gripper arms 221a, 221b, to enable holding of the first layer 102 and for removing the first layer 102 entirely from the second layer 104. In such embodiments, the gripper device 220 is actuated by the first drive unit via the first end effector arm.

FIG. 6c is a top view of the system shown in FIG. 6a, illustrating removal of the first layer 102 via the gripper device 220 in accordance with one exemplary embodiment. In the illustrated embodiment, the gripper device 220 is actuated by the first drive unit to move along at least one axis 226a for removing the first layer 102 entirely from the second layer 104. In some other embodiments, the support device 300 may move along at least one axis for removing the first layer 102 entirely from the second layer.

Embodiments of the present disclosure discussed herein enable repetitive and reliable removal of backing papers, and have the capability to remove various types of backing paper only by varying the motion of the drive units. No damage is caused to the underlying material. Other advantages include labor savings, increased productivity, and improved quality through automation.

While certain features have been illustrated and described herein, many modifications and changes will occur by those skilled in the art. It is, therefore, to be understood that the appended claims are intended to cover all such modifications and changes as fall within the true spirit of the invention.

1. A system comprising:
a first drive unit;
a release device coupled to the first drive unit and configured to contact one layer among a first layer disposed on a second layer; wherein another layer among the first layer and the second layer is held by a support surface of a support device; wherein the release device is configured to apply a release force against an edge portion of the one layer; wherein at least one of the release device and the support device is movable to peel the edge portion of the one layer from the other layer; and
a gripper device coupled to the first drive unit and configured to hold the peeled edge portion to remove the one layer entirely from the other layer.

2. The system of claim 1, wherein the release device is a vacuum device.

3. The system of claim 1, wherein the first drive unit comprises at least one of a spring loaded system, a drive motor, a drive cylinder, a gear drive unit, a pneumatic unit, a robot, and a gantry.

4. The system of claim 3, wherein the first drive unit comprises a plurality of first end effector arms; wherein the first drive unit is configured to independently move each first end effector arm.

5. The system of claim 2, wherein the vacuum device comprises a vacuum source coupled to a vacuum channel for applying the release force against the edge portion of the one layer; wherein the release force is a suction force.

6. The system of claim 2, wherein the vacuum device is movable towards and away from the one layer to peel the edge portion of the one layer from the other layer.

7. The system of claim 2, wherein the support device is movable towards and away from the vacuum device to peel the edge portion of the one layer from the other layer.

8. The system of claim 2, wherein the vacuum device and the support device are movable simultaneously or independently to peel the edge portion of the one layer from the other layer.

9. The system of claim 2, wherein the gripper device is movable along at least one axis for removing the one layer entirely from the other layer.

10. The system of claim 2, further comprising the support device having the support surface, wherein the support surface is at least one of a cooled surface, a vibrating surface, a sticky surface and a non-sticky surface.

11. The system of claim 10, wherein the support surface comprises at least one of a high vacuum region and a low vacuum region.

12. The system of claim 11, wherein the support surface comprises a plurality of holes coupled to a vacuum source.

13. The system of claim 11, wherein the support surface comprises a plurality of holes coupled to a fluid blower.

14. The system of claim 10, further comprising a second drive unit coupled to the support device movable along at least one axis for removing the one layer entirely from the other layer.

15. The system of claim 14, further comprising a plurality of sensors for sensing at least one of contacting of the one layer by the vacuum device, contacting of the other layer by the support surface of the support device, holding of the peeled edge portion by the gripper device, removal of the one layer entirely from the other layer, and a position of the other layer on the support surface of the support device.

16. The system of claim 15, further comprising a control unit communicatively coupled to the plurality of sensors, and configured to independently control at least one of the first drive unit and the second drive unit based on output signals from the plurality of sensors.

17. The system of claim 16, wherein the control unit is further configured to independently control the gripper device, the support device, and the vacuum device.

18. The system of claim 1, further comprising a blower to inject a fluid between the first layer and the second layer to aid in peeling the edge portion of the one layer from the other layer.

19. The system of claim 1, further comprising a peeled edge holder device configured to support the peeled edge portion of the one layer, so as to prevent falling of the one layer on to the other layer.

20. A method comprising:
applying a release force via a release device against an edge portion of one layer among a first layer disposed on a second layer;
holding another layer among the first layer and the second layer by a support surface of a support device;
moving at least one of the support device, and the release device to peel the edge portion of the one layer from the other layer;
holding the peeled edge portion of the one layer through a gripper device; and
moving at least one of the support device and the gripper device to remove the first layer entirely from the second layer.

21. The method of claim 20, comprising controlling speed of at least one of the support device and the release device to peel the edge portion of the one layer from the other layer.

22. The method of claim 20, further comprising moving the gripper device along at least one axis for removing the first layer entirely from the second layer.

23. The method of claim 20, further comprising moving the support device along at least one axis for removing the first layer entirely from the second layer.

24. The method of claim 20, further comprising sensing at least one of contacting of the one layer by the release device, contacting of the other layer by the support surface of the support device, holding contacting of the peeled edge portion by the gripper device, removal of the first layer entirely from the second layer, and detecting a position of the other layer on the support surface of the support device, via a plurality of sensors.

25. The method of claim 24, further comprising independently controlling a first drive unit configured to drive the release device and a second drive unit configured to drive the support device, via a control unit based on output signals from the plurality of sensors.

26. The method of claim 25, further comprising independently controlling each first end effector arm among a plurality of first end effector arms of the first drive unit.

27. The method of claim 25, further comprising independently controlling the gripper device, the support device, and the release device, via the control unit.

28. The method of claim 20, further comprising injecting a fluid between the first layer and the second layer via a blower, to aid in peeling the edge portion of the one layer from the other layer.

29. The method of claim 20, further comprising supporting the peeled edge portion of the first layer via a peeled edge holder device, so as to prevent falling of the first layer on to the second layer.

30. The method of claim 20, further comprising affixing the other layer to the support surface of the support device.

31. The method of claim 20, further comprising applying a holding force against the other layer through a plurality of holes in the support surface of the support device to hold the other layer against the support surface of the support device.

32. The method of claim 31, further comprising controlling the holding force individually through each hole among the plurality of holes.
